(19) United States
(12) Patent Application Publication
(10) Pub. No.: US 2016/0236399 A1
(43) Pub. Date: Aug. 18, 2016

(54) BANNER MAKING MACHINE

(71) Applicant: Miller Weldmaster Corporation, Navarre, OH (US)

(72) Inventors: Brent G. Nussbaum, Dalton, OH (US); James D. Graves, East Sparta, OH (US)

(73) Assignee: Miller Weldmaster Corporation

(21) Appl. No.: 14/725,279

(22) Filed: May 29, 2015

Related U.S. Application Data
(63) Continuation-in-part of application No. 14/621,497, filed on Feb. 13, 2015.

(51) Int. Cl. B29C 53/04; G09F 17/00

(52) U.S. Cl. CPC B29C 53/04; G09F 17/00; B29L 2031/722

(57) ABSTRACT

A system for making a banner having reinforced edges and grommets includes a self-contained banner making machine including a welding device and a grommet riveting device within the machine. A sheet of banner webbing material for is configured to be fed through the banner making machine. A first hem is created in a folding devices upstream from the welding device. A grommet is riveted through the hem having double thickness banner material by the riveting device. The banner making machine includes a banner material flowstream pathway, including first and second sides of the pathway. The welding device is between the entrance and exit of the machine. The riveting device or a first grommet riveter is also between the entrance and exit positioned downstream from the welding device.

### CROSS-REFERENCE TO RELATED APPLICATIONS

This application is a continuation in part application that claims priority from U.S. patent application Ser. No. 14/621,497, filed Feb. 13, 2015; the disclosure of which is incorporated herein by reference as if fully re-written.

### BACKGROUND

1. Technical Field

The present invention relates generally to the field of manufacturing machines. More particularly, the present invention relates to banner making machines. Specifically, the present invention relates to a banner making machine that welds a strip of reinforcing material to a banner and rivets a grommet through the reinforcing strip and the banner.

2. Background Information

Banners with printed information thereon are a useful way of conveying ideas or announcements to the public. Other banners may have promotional or advertisement material printed thereon. Often these types of banners are displayed outside and are therefore exposed to natural elements such as heat, cold, rain, and wind. When banners hang in the wind from a cord, there is a tendency for the banners to rip or tear at the connection point, usually a grommet, due to wind forces exerted on the banner and grommet. To overcome the stress forces exerted on the banner, some banners are constructed with a reinforcing strip of material extending from end to end near a side edge of the banner, preferably on the back side of the banner so as to not interfere with the printed display information.

Currently, the state of the art includes banner welding machines that have the ability to weld a strip a reinforcing material to a web of banner material. Additionally, the state of the art also includes riveting machines that are able to fire a grommet through a banner having a reinforcement strip welded thereto. These two separate and distinct machines mentioned above are often large, and require production downtime when transferring the banner from one machine to the other.

### SUMMARY

Issues continue to exist with banner welding machines and banner riveting machines as understood in the prior art. Namely, there exists a need to streamline the banner making process for producing a banner that includes a reinforcing strip welded thereto and grommets riveted through the banner and the reinforcement strip. Additionally, a need exists for banner making machines that can reinforce and edge of the banner without the need for a reinforcing strip, for example, implementing a folded banner defining a welded hem. The present invention addresses these and other issues.

In one aspect, an embodiment may provide a banner making machine comprising: a machine entrance forward from a machine exit; a banner material flowstream pathway, including first and second sides, extending from the machine entrance to the machine exit; a first banner folding device having first and second ends, the first banner folding device between the entrance and exit adjacent one side of the pathway configured to fold one edge of banner material about itself creating a first hem; and a first grommet riveter between the entrance and exit positioned downstream from the folding device to rivet a grommet through the hem.

In another aspect, an embodiment may provide a method of making a banner, comprising the steps of: feeding banner material having a first thickness into an entrance of a banner making machine, the banner material including first and second spaced apart edges, wherein the banner making machine moves the banner material along a material pathway; folding the first edge in a folding device, wherein the banner material has a first width before the folding device and a second width after the folding device, and the second width less than the first width, to create a first hem; wherein the first hem has double thickness; and riveting a grommet with a riveting device through double thick banner material prior to the banner material passing a machine exit.

Further, an embodiment may provide a system for making a banner having reinforced edges and grommets includes a sell-contained banner making machine including a welding device and a grommet riveting device within the machine. A sheet of banner webbing material for is configured to be fed through the banner making machine. A first hem is created in a folding devices upstream from the welding device. A grommet is riveted through the hem having double thickness banner material by the riveting device. The banner making machine includes a banner material flowstream pathway, including first and second sides of the pathway. The welding device is between the entrance and exit of the machine. The riveting device or a first grommet riveter is also between the entrance and exit positioned downstream from the welding device.

In yet another aspect, an embodiment may provide a banner making machine comprising: a banner material flowstream pathway, including first and second sides of the pathway; a machine entrance positioned upstream from a machine exit; a first strip welder between the entrance and exit adapted to weld a strip of reinforcing material to a web of banner material; and a first grommet riveter between the entrance and exit positioned downstream from the first strip welder adapted to rivet a grommet through the reinforcing material welded to the banner material creating a completed banner.

Another aspect may provide a method for making a banner comprising the steps of: feeding a banner into an entrance of a self-contained banner making machine including an exit downstream from the entrance defining a banner flowstream pathway therebetween; welding a strip of reinforcement material to the banner between the entrance and exit with a strip welder, the strip welder defining a portion of the pathway; and riveting a grommet through the banner and strip welded together between the entrance and exit with a grommet riveter, the riveter defining a portion of the pathway.

Another aspect may provide a system for making a banner having reinforced edges and grommets comprising: a self-contained banner making machine including a welding device and a grommet riveting device within the machine; a sheet of banner webbing material for feeding through the banner making machine; a strip of reinforcement material that is welded to the banner by the welding device in the banner making machine; and a grommet that is riveted through the banner material with the strip of reinforcement material welded thereto by the riveting device.

In yet another aspect, an embodiment may provide a system for making a banner having reinforced edges and grommets includes a self-contained banner making machine including a welding device and a grommet riveting device within the machine. A sheet of banner webbing material is configured to be fed through the banner making machine. A strip of reinforcement material is welded to the banner by the welding device in the banner making machine. A grommet is riveted through the banner material with the strip of reinforcement material welded thereto by the riveting device. The banner making machine includes a banner material flowstream pathway, including first and second sides of the pathway. The welding device or a first strip welder is between the entrance and exit of the machine. The riveting device or a first grommet riveter is also between the entrance and exit positioned downstream from the first strip welder.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a diagrammatic view of a banner making machine of the present invention;

FIG. 2 is a side elevation view of some internal components of the banner making machine;

FIG. 3 is a top view of the banner making machine;

FIG. 4 is a top view of the banner making machine depicting a carriage assembly movable from an extended position to a narrow position;

FIG. 5 is a cross-section taken along line 5-5 in FIG. 3 depicting a banner positioned squarely on a table upstream from the entrance to the banner making machine;

FIG. 6 is an alternate embodiment of a banner having a fan fold viewed in cross-section taken along line 5-5 in FIG. 3;

FIG. 7 is an operational top view of the banner making machine;

FIG. 8 is an operational top view of the banner making machine;

FIG. 9 is an enlarged side view of the operation of a clamp assembly on the banner making machine;

FIG. 10 is an operational top view of the banner making machine;

FIG. 11 is an operational top view of the banner making machine;

FIG. 12 is an operational enlarged side view of the banner making machine depicting a strip of reinforcing material and a banner material being heated and welded together through a set of pinch rollers;

FIG. 13 is an operational top view of the banner making machine;

FIG. 13A is an operational top view of the banner making machine depicting a plurality of crosshair indicators pre-printed on the banner material;

FIG. 14 is an operational enlarged side view of the banner making machine depicting a grommet being riveted through the banner material and the reinforcement strip;

FIG. 15 is an operational top view of the banner making machine;

FIG. 16 is a front elevation view of a completed banner having grommets riveted near the corners of the completed banner;

FIG. 17 is a front elevation view of a completed banner made by the banner making machine of the present invention with uniform grommets near the top and bottom edges of the completed banner;

FIG. 18 is a top view of an embodiment including a folding device on the banner making machine to create a first hem;

FIG. 19 is a side view of the folding device in operation taken along line 19-19 in FIG. 18; and

FIG. 20 is a cross section of a welding hem of banner material folded in the folding device represented in FIG. 18.

Similar numbers refer to similar parts throughout the drawings.

### DETAILED DESCRIPTION

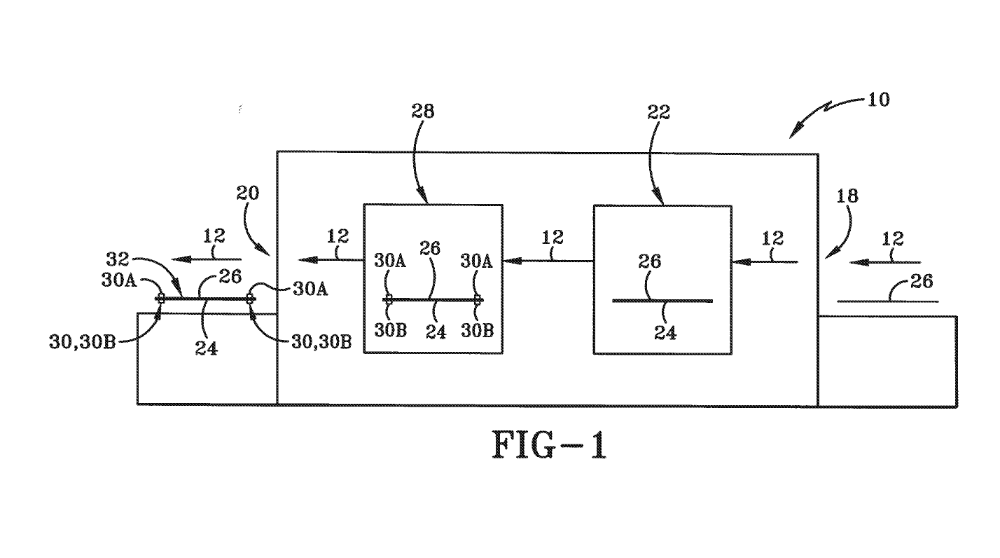

The new banner making machine of the present invention depicted throughout FIGS. 1-17 is shown generally 10. Banner making machine 10 improves the ways a banner having a reinforcement strip welded thereto and grommet riveted therethrough is manufactured.

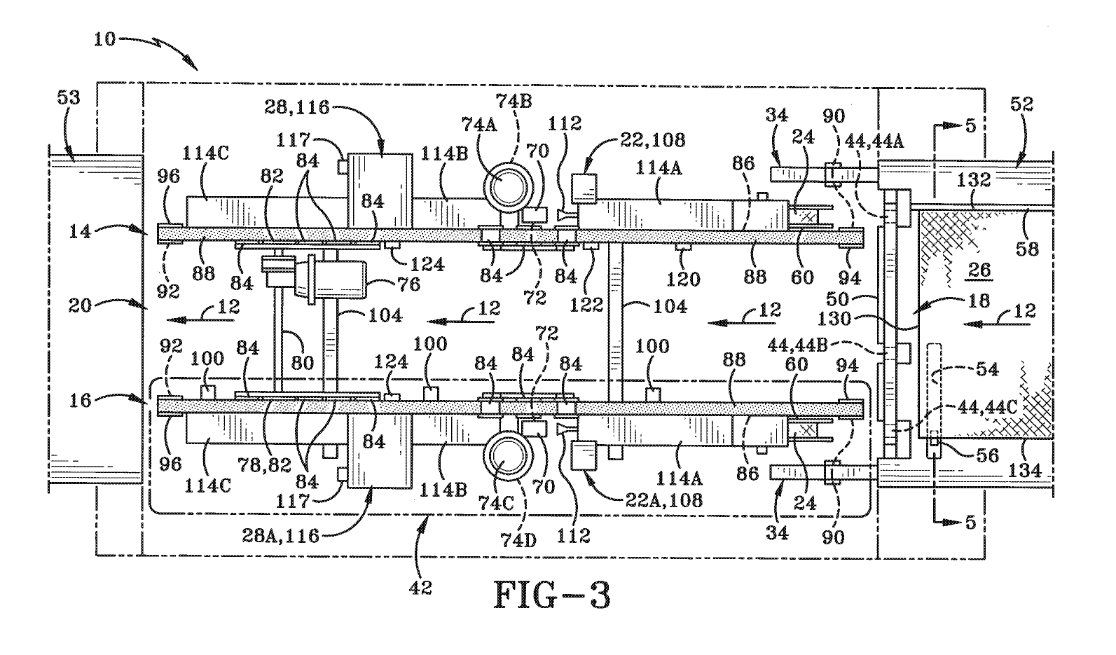

As depicted in diagrammatic FIG. 1, banner making machine 10 comprises a banner material flowstream pathway 12, including first and second sides 14, 16 (FIG. 3) of the pathway, a machine entrance 18 positioned upstream from a machine exit 20, a first strip welder 22 between the entrance 18 and exit 20 adapted to weld a strip of reinforcing material 24 to a web of banner material 26, and a first grommet riveter 28 between the entrance 18 and exit 20 positioned downstream from the first strip welder 22 adapted to rivet a grommet 30 through the reinforcing material 24 welded to the banner material 26 creating a finished banner 32.

Prior to further discussion relating to banner making machine 10, it should be noted that some components of banner making machine 10 are duplicated on respective sides 14, 16 of machine 10. For clarity and purposes of this explanation, some components in some figures are not shown, however it is to be understood by the reader that the components can be duplicated on respective sides 14, 16 as will be explained in further detail below.

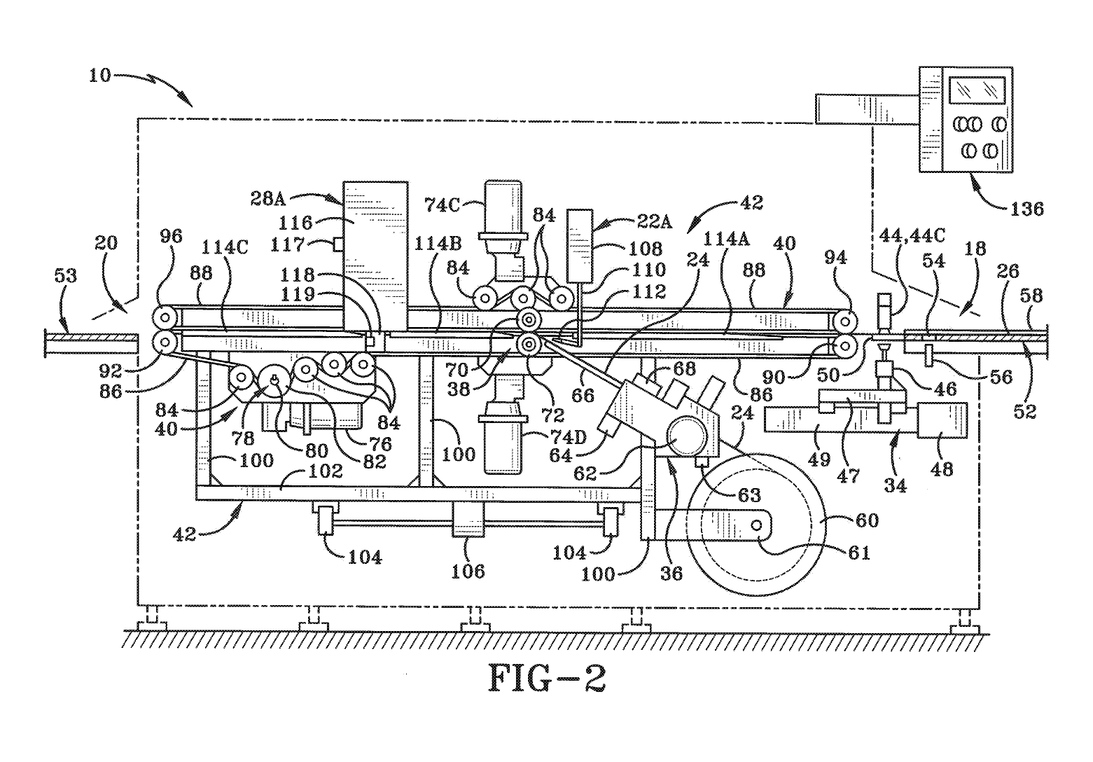

As depicted in FIG. 2, banner making machine 10 is shown in a side elevation view and may further comprise a clamp assembly 34, a feeder assembly 36, pinch rollers 38, drive system 40, and a carriage assembly 42.

Clamp assembly 34 includes an upper clamp 44 and a lower clamp 46. Upper clamp 44 is positioned above lower clamp 46 when viewed from the side, defining a passageway therebetween. Upper and lower clamps 44, 46 are operatively connected. Each upper and lower clamp may be selectively movable in the vertical direction to decrease the gap distance, clamping an object therein as desired by user. In one embodiment, clamp assembly 34 further includes an actuator or motor 48 to mechanically close upper and lower clamps 44, 46. Clamp assembly 34 further includes a trolley assembly 47 to slide on tracks 49. Upper clamp 44 and lower clamp 46 are operatively connected to trolley 47 such they are longitudinally movable in the direction of pathway 12 along track 49. In one embodiment, motor 48 that actuates the closing of upper clamp 44 and lower clamp 46 may also operate the longitudinal movement of trolley assembly 47 carrying clamps 44, 46. Track 49 is generally parallel with the flow direction of pathway 12. The upstream end of track 49 is generally forward of rear edge 50 of table 52 and the downstream end of track 49 is downstream from a forward end of the drive system 40. As shown in FIG. 2, the forward end of drive system 40 is rollers 90, 94. As depicted in FIG. 2, track system 49 is positioned below table 52 as well as various support plates. However, other embodiments are entirely possible where the track system may be located in other positions within machine 10. Clamp assembly 34 is positioned downstream from entrance 18 and upstream from drive system 40. Further, while only a single upper and lower clamp 44, 46 is depicted in FIG. 2, it is understood that a plurality of clamps are positioned transversely relative to path 12 (See clamps 44A, 44B, and 44C in FIG. 3). Upper and lower clamps 44, 46 are disposed within cutout notches extending forwardly from a rear edge 50 of a table 52.

Table 52 defines an aperture 54, extending generally transverse relative to pathway 12. A first square sensor 56 is positioned underneath aperture 54, configured to sense and view substrate (e.g. banner 26) existing above aperture 54. Sensor 56 is positioned upstream relative to clamp assembly 34. Table 52 further includes a vertically extending lip 58 disposed longitudinally aligned with pathway 12. A rear edge of lip 58 terminates forwardly of rear edge 50 and defines a portion of a notch cutout area retaining a portion of clamp assembly 34 therein. The vertical portion of lip 48 is perpendicular to table 52. Additionally, the longitudinal length of lip 58 is perpendicular to an edge of table 52 defining a square relationship therebetween.

Feeder assembly 36 includes a reel 60 about which reinforcing strip 24 is wound, a feeder motor 62, a sensor 64, a support plate 66, and a cutter 68. Reel 60 is a generally cylindrical member coupled with carriage 42 via support arm 61. Reinforcing strip 24 wound about reel 26 is aligned with and extends through motor 62. Motor 62 is configured to drive strip 24 in an unwinding manner from reel 60, up and over support plate 66 and towards pinch rollers 38. Sensor 64 senses when strip 24 needs to be cut, sending a signal to cutter 68 to cut the reinforcing strip 24 to a desired length. A sensor 63 may also be coupled with feeder assembly 36 configured to sense the amount of wound reinforcing strip material 24 contained on reel 60. As reel 60 unwinds and the amount of reinforcing material 24 is unwound, sensor 63 may send a signal to a control system that alerts an operator that the reel is running low on material 24 and may need replaced. While the shown embodiment indicates sensor 63 and sensor 64 as separate and distinct, clearly it is understood that these two sensors 63, 64 may be combined in a single sensor as one having ordinary skill in the art would understand.

Pinch rollers 38 include an upper roller 70 positioned above a lower roller 72. Upper pinch roller 70 is operatively coupled to a first drive motor 74A (FIG. 3) or 74C and lower pinch roller 72 is coupled to a second motor 74B (FIG. 3) or 74D. Pinch roller assembly 38 is positioned downstream from support plate 66 on feeder assembly 36. Further, pinch rollers 38 are positioned downstream from first welder 22. Pinch rollers 38 are disposed within a space defined between a longitudinally extending support plate 114A and a longitudinally extending support plate 114B. Between plates 114, 114B, upper and lower pinch rollers 70, 72 are generally aligned directly downstream from a weld plate 112 on heater 22 (weld plate 112 may also be referred to as wedge 112). Further, while it is understood that a pair of pinch rollers 38 are respectively placed on each side 14, 16 along pathway 12 in machine 10, the pinch rollers 38 are farther to the outside relative to a drive belt 88, which will be described in further detail below.

Drive system 40 includes a drive motor 76, a slip union 78, an axle 80, a drive wheel 82, a plurality of tensioners 84, a lower drive belt 86, and an upper drive belt 88. Lower drive belt 86 rotates around a front roller 90 and a rear roller 92. Upper belt 88 rotates about front roller 94 and a rear roller 96. Front roller 94 is positioned above lower front roller 90 and rear roller 96 is positioned above rear roller 92. In one exemplary embodiment, upper belt 88 is an idle belt only driven by frictional contact movement of lower belt 86 as lower belt 86 is driven by motor 76. Clearly, other embodiments are entirely possible which would include upper belt 88 driven by a motor in a conventionally understood manner. Similar to other components previously described, drive belts 86, 88 extend along each side 14, 16 of pathway 12. In one particular embodiment, a single drive motor 76 drives both sets of belts 86, 88 on each respective side 14, 16 of pathway 12. Axle 80 extends transversely across pathway 12 and drive rollers 82 are coupled to axle 80 adjacent each side 14, 16 of pathway 12. Slip union 78 enables the single motor 76 to drive belts 86, 88 on each respective side 14, 16 of pathway 12 simultaneously. Further, slip union 78 enables slight adjustments of speed of the belts 86, 88 should they become out of sync with the speed of the other belts operating on an opposite side pathway 12.

Carriage assembly 42 is configured to carry components of banner making machine 10 that are positioned along left side 16 (FIG. 3). Carriage assembly 42 includes support frames 100 that extend generally vertical and connect with a generally horizontal support frame member 102. A pair of tracks 104 extends transversely generally perpendicular to pathway 12, allowing carriage assembly 42 to travel thereon. Carriage assembly 42 further includes a linear actuator 106 that moves carriage assembly 42 on tracks 104.

With continued reference to FIG. 2, welder 22 includes a heater 108, a heat transfer member 110, and a heatable wedge 112. Heat wedge 112 is in communication with heater 108 through heat transfer member 110 such that heater 108 heats 112 to a desired temperature. Wedge 112 is positioned closely adjacent to plate 66 on feeder assembly 36. Wedge 112 is further closely adjacent and just downstream of support plate 114 atop which banner material 26 travels, which will be described in greater detail below. Wedge 112 is positioned just upstream from pinch rollers 38 and is configured to heat reinforcing strip 24 and banner material 26 simultaneously just upstream from pinch rollers 38. Wedge 112 is disposed in the space defined between support plates 114A and 114B. Welder 22 is contemplated as being an electric fabricating welder as one having ordinary skill in the art would understand. However, clearly other fabric welding devices are entirely possible. The temperature of the wedge is controlled by temperature logic associated with control 136.

Grommet riveter 28 includes an upper grommet bin 116, an upper sensor 117, a lower sensor 119, and a lower grommet unit 118 configured to fire (i.e., rivet) two halves of a grommet together, riveting them through a piece of reinforcing strip 24 welded to banner 26. Grommet riveter 28 is positioned downstream from a support plate table segment 114B and upstream from a support plate table segment 114G. Grommet riveter 28 is positioned downstream from welder 22 and upstream from exit 20.

As depicted in FIG. 3, certain components of banner making machine 10 are provided by complementary or mirrored units, on respective left and right sides 14, 16 of device. While FIG. 2 generally refers to the components of the device, FIG. 3 makes reference as to their respective first and second side relationships 14, 16 relative to pathway 12. Adjacent second side 16 of pathway 12, device 10 further includes a second welder 22A and a second grommet riveter 28A. Carriage assembly 42 carries welder 22A and riveter 22A thereon.

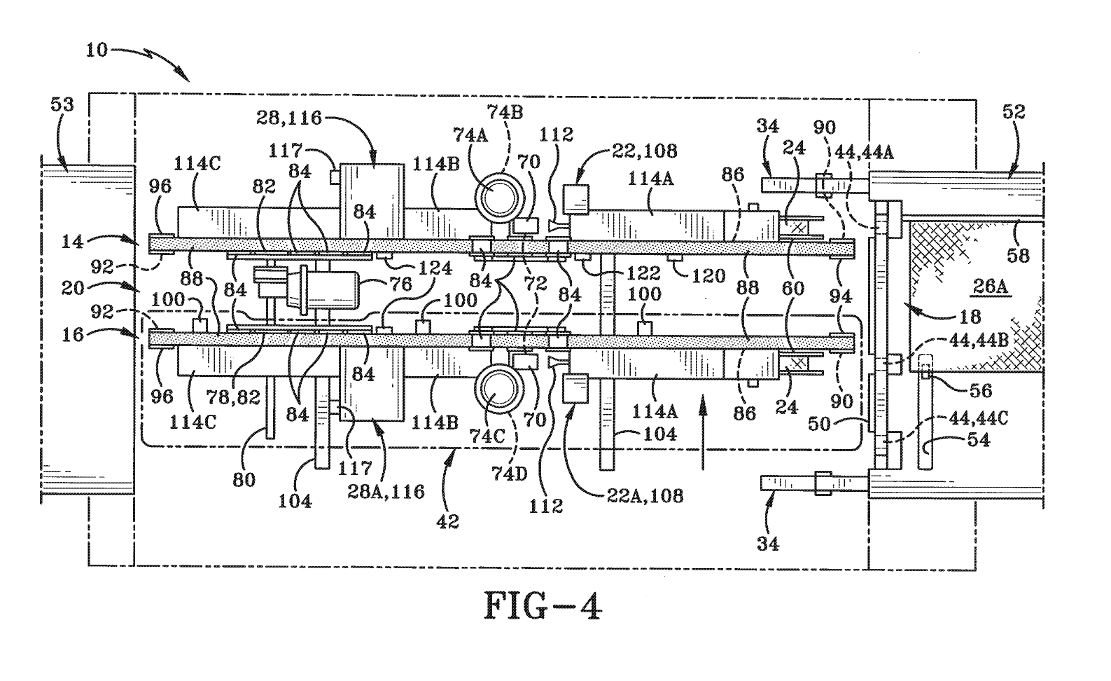

Clamp assembly 34 further includes a first upper clamp 44A, a second upper clamp 44B, and a third upper clamp 44C. Upper clamp 44A is closely adjacent first side 14 and is configured to clamp banner material 26 adjacent first side of banner 132. Third upper clamp 44C is closely adjacent second side 16 of pathway 12 as configured to clamp adjacent second edge 134 of banner material 26. In one embodiment, second clamp 44B clamps adjacent the center of banner material 26. However, as depicted in FIG. 4, clamp 44B may clamp adjacent second edge 134 when banner 26 has a width less than the maximum throat width at entrance 18 of device 10. Throat width from first side 14 to second side 16 is approximately 30 inches at entrance 18. The throat width at entrance 18 is measured transversely perpendicular to pathway 12 from first side 14 to second side 16.

With continued reference to FIG. 3, pluralities of sensors are positioned along the sides 14, or 16, of banner material pathway 12. A first banner sensor 120 is positioned along a side of the pathway downstream from roller 94 and upstream from welder 22. Further, while references made to sensor 120 being located along first side 14, it is clearly possible that sensor 120 may exist on the other side 16 of pathway 12. A second banner sensor 122 is positioned downstream from first banner sensor 120 and upstream from pinch roller 38. A third banner sensor 124 is positioned downstream from welder 22 closely adjacent to riveting assembly 28 along first side 14. The operation of sensors 120, 122, and 124 will be described in further detail below.

As depicted in FIG. 4, carriage assembly 42 is movable in a transverse direction relative to pathway 12 such that the operating width between welding devices 22 and 22A may vary depending on the width of material 26 to be processed through machine 10. The position of the welding and riveting elements 22A, 28A respectively, along second side 16 in FIG. 3 is considered to be an extended first position, whereas the position of carriage assembly 42 in FIG. 4 is considered to be a narrow second position. Carriage assembly 42 moves via linear actuator 106 between first and second positions. Carriage assembly 42 moves to a selectively desired width prior to feeding banner 26 along pathway 12 such that second side 16 remains at a fixed width relative to first side as material 26 moves along pathway 12.

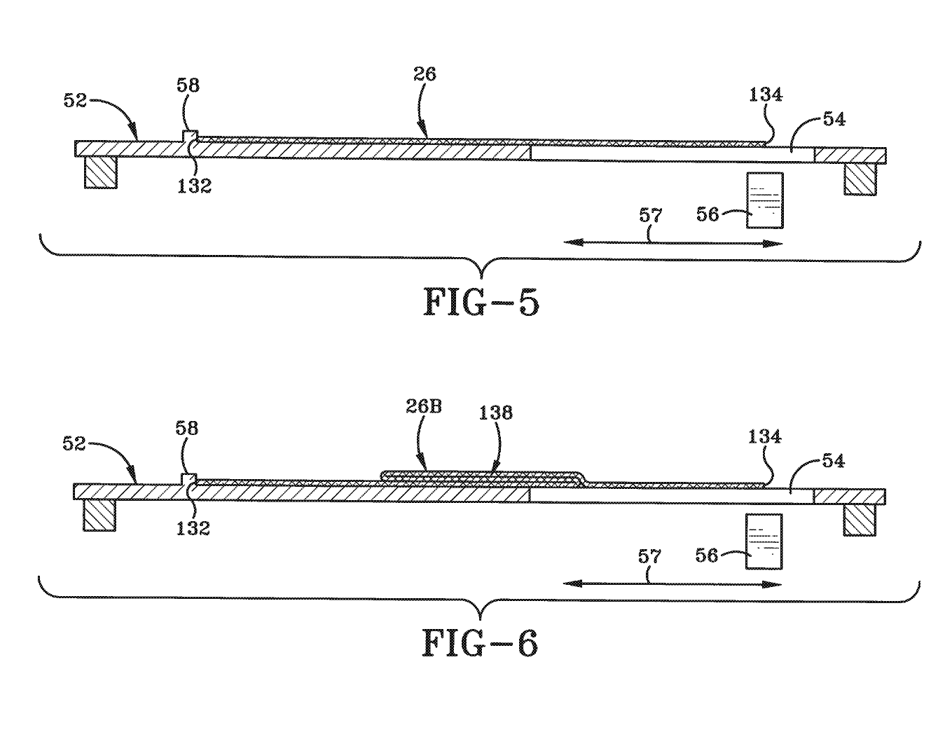

As depicted in FIG. 5, banner material 26 is positioned atop table 52 and aligned with lip 58 such that first edge 132 of banner 26 is square. The perpendicularly extending vertical nature of lip 58 permits square alignment of banner 26 atop table 52. Second edge 134 terminates above aperture 54. Transverse movement of sensor 56 in the direction of movement arrow 57 positions sensor 56 beneath second edge 134.

As depicted in FIG. 6, a banner 26B may have a fan fold 138 disposed between first edge 132 and second edge 134. The advantage of fan fold 138 is it permits a banner having a width greater than the throat width at entrance 18 to be welded through machine 10. In one particular embodiment, the width of banner 26B (measured from first edge 132 to second edge 134) may be as great as 10 feet and fan fold 138 folded over multiple times such that the overall width from edge 132 to 134 is less than or equal to about 30 inches. Folded banner 26B fits through the throat width of 30 inches at entrance 18 to move along pathway 12. Further, while fan fold 138 shows banner 26B as doubled over one time, clearly it is understood as one having ordinary skill in the art with folding banner material that multiple fan folds could occur between first edge 132 and second edge 134 to achieve an overall width measured from 132 to 134 of less than about 30 inches. Fan fold 138 has at least triple thickness of banner material 26B relative to the unfolded portions.

Prior to description of the operation of the present invention 10, non-limiting aspects and advantages of the present invention 10 are described. The self-contained banner making machine 10 welds a reinforcing strip 24 to a banner material 26 and then rivets grommets to manufacture a completed banner 32 in a single machine 10. The banner making machine 10 allows transverse movement of one side (16) of the device relative to the banner pathway 12 so as to make machine 10 adjustable to finish banners of varying widths. The banner making machine 10 further includes a plurality of sensors for indexing the banner material 26 as it moves along the pathway through the belt drive system 40. Further, the belt drive system 40 is controlled by a single motor 76 utilizing a slip union 78 coupled to an axle 80, thereby allowing the drive belts on each respective side 14, 16 of machine 10 to travel at different rates if needed. One non-limiting example would be a scenario in which the banner 26 traveling downstream was not square and one drive belt needed to be sped up to square off the movement of the banner material moving downstream.

In operation with reference to FIG. 3, the banner 26 is first placed on table 52 in a manner such that it is square with lip 58. An operator moves the leading edge 130 over aperture 54 towards clamps 44. The clamps 44, 46 in FIG. 3 are shown in the open position which permits banner 22 to be pushed through the gap defined between upper clamp 44 and lower clamp 46. With banner 26 resting in the gap between upper clamp 44 and lower clamp 46, a computer control system 136 will then determine if the banner making machine 10 is ready for operation.

Computer control system 136 includes sensor indexing logic configured to move at least one sensor 56 within the aperture 54 to determine, amongst other things, the width of the banner, as well as whether or not the banner is square with the pathway 12. The sensor indexing logic may further control the other sensors 120, 122, and 124 or they may be independently controlled under their own sensor indexing logic.

As depicted in FIG. 4, the present invention has the ability to weld and rivet grommets to two sides of a banner as the banner flows downstream along pathway 12, wherein the banner may have a variety of widths. Banner 26 depicted in FIG. 4 has a width narrower than that of the banner 26 depicted in FIG. 3. When a banner having a narrower width is approaching the entrance 18 of the machine 10, sensor 56 determines the width and operatively communicates via electrical communication with linear actuator 106 to move carriage assembly 42 to a width complementary to the banner. FIG. 4 shows a position of the carriage assembly moving the second side 16 of the components carried by carriage 42 closer to first side 14 to the narrow second position.

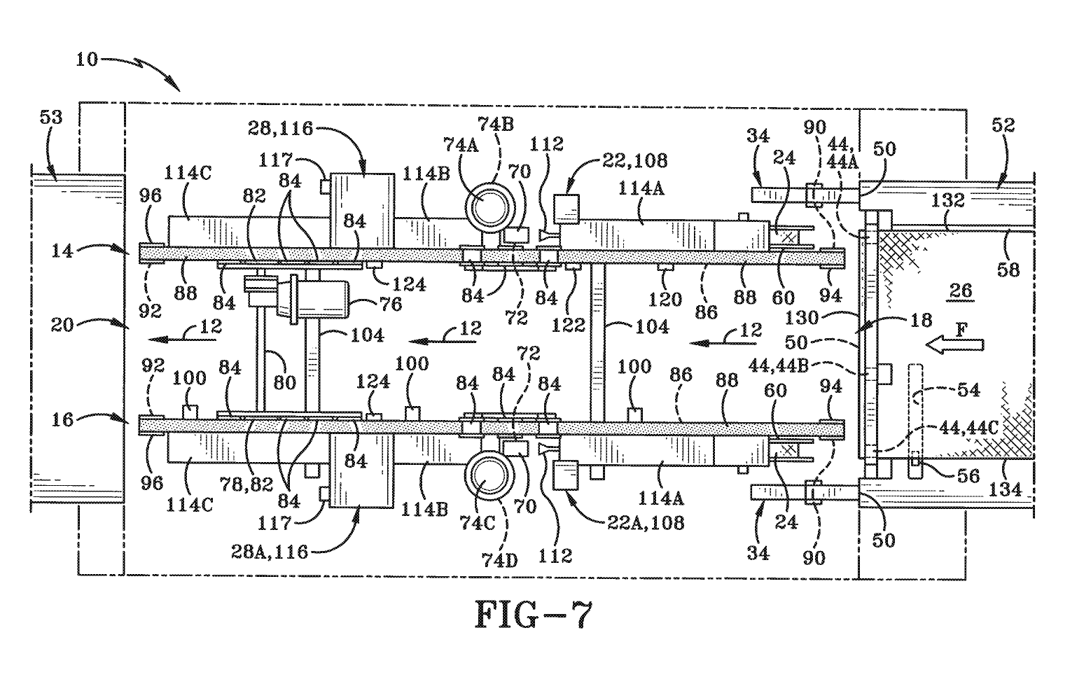

In operation, and with reference to FIG. 7, banner 26 is placed upon table 52 and has a width of about 30 inches. Banner 26 is placed over aperture 54 and inserted a short distance between gap on clamp assembly 34 such that leading edge 130 is downstream from upper and lower clamps 44, 46. Sensor 56 moves transversely and generally orthogonal relative to flowstream pathway 12 until sensor 56 aligns with second edge 134 of banner 26. Sensor 56 communicates with control system 136 determining whether banner 26 is square relative pathway 12. In the event banner 26 is not square, control system 136 will indicate to an operator that the banner is not square and needs to be squared prior to feeding the banner downstream. Further, while banner 26 is described herein as a single preprinted banner, clearly a source assembly upstream from the self-contained banner making machine 10 may be configured to supply an amount of banner material selectively from one of a roll of material.

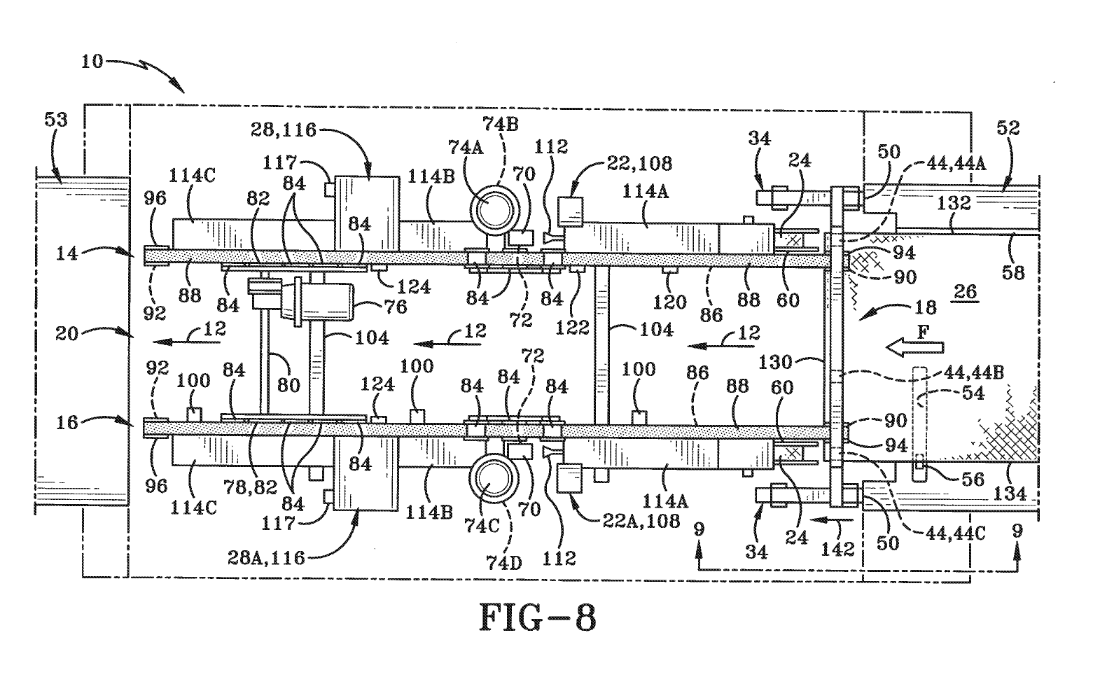

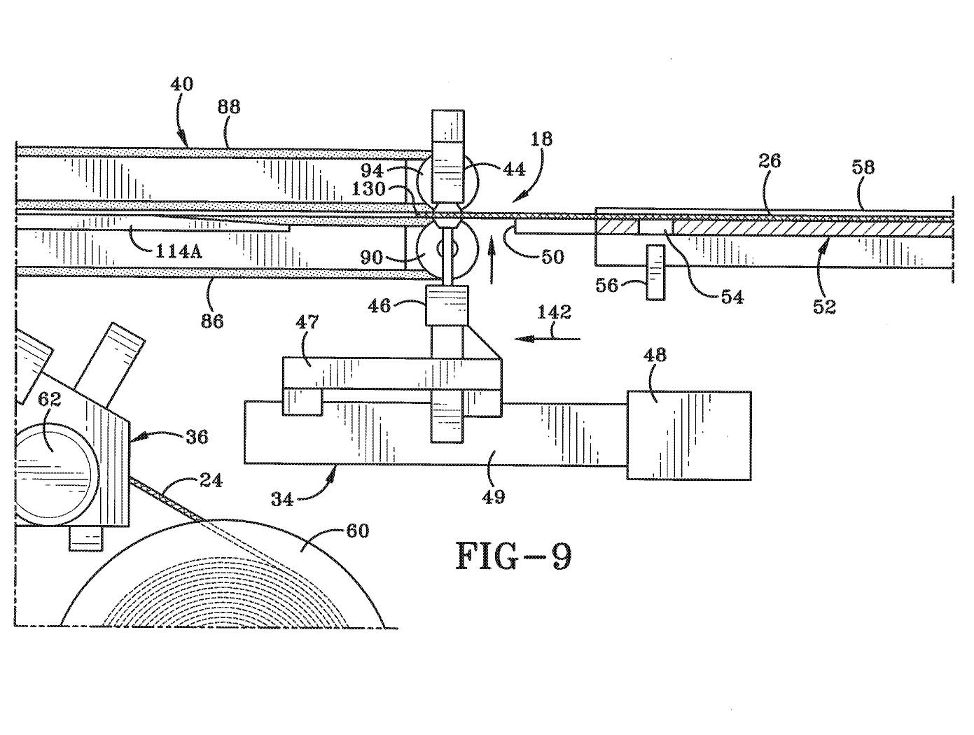

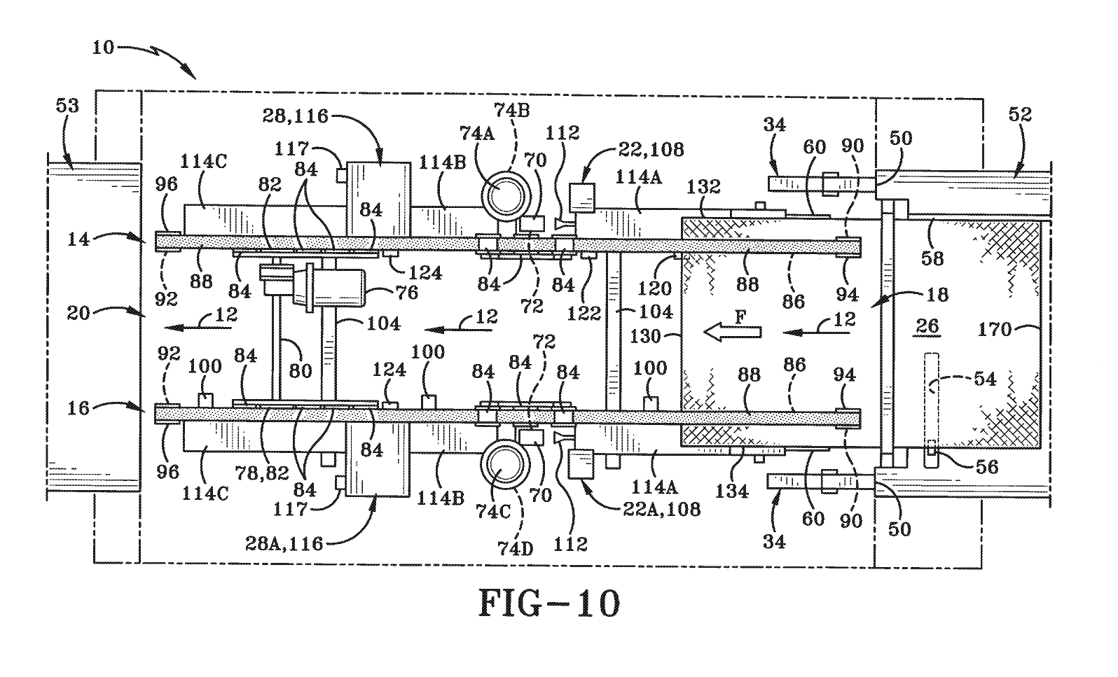

In operation, and with reference of FIG. 8 and FIG. 9, lower clamp 46 raises in the direction of movement arrow 140 to clamp banner 26 between upper clamp 44 and lower clamp 46. With banner 26 clamped between clamps 44, 46, trolley 47 is actuated along tracks 49 by motor 48 in the direction of arrow 142. The leading edge 130 of banner 26 is grasped by upper belt 88 and lower belt 86 between rollers 94 and 90 respectively. Lower belt 86 contacts the downwardly facing surface of banner 26 to move it in the direction of arrow 142. Belt 88 contacts the upwardly facing surface of banner 26 to draw it in the direction of movement arrow 142. Clamp assembly 34 releases its grasp of banner 26 by moving lower clamp 46 in the direction opposite that of movement arrow 140. Leading edge 130 is then driven by belts 86, 88 towards support plate 114A. Belts 86, 88, located on each side 14, 16 of machine 10, grasp banner 26 inside of first and second edges 132, 134 of banner material. The drive belts 86, 88 operating on each side 14, 16 move or cause banner to flow in the direction of arrow F which is collinear with pathway 12.

In operation with reference to FIG. 10, banner material 26 continues to flow as driven by the drive system 42 downstream along pathway 12. Leading edge 130 of banner 26 passes by sensor 120. Sensor 120 senses the location of the leading edge and may determine whether the banner is still square moving along pathway 12. Sensor 120 may also sense the speed at which banner 26 is flowing downstream along pathway 12 in the direction of arrow F and is in operative communication with control system 136 and feeder assembly 36.

Control system 136 may include a banner positioning logic to determine the speed as well as relative square position of the banner 26 as it moves along the pathway 12. Banner positioning logic may also include an instruction sequence sent to feeder assembly 36 to begin unwinding reinforcing strip 24 from reel 60 at a rate similar to that of banner flow such that reinforcing strip 24 and banner material 26 meet at pinch rollers 38 for joining.

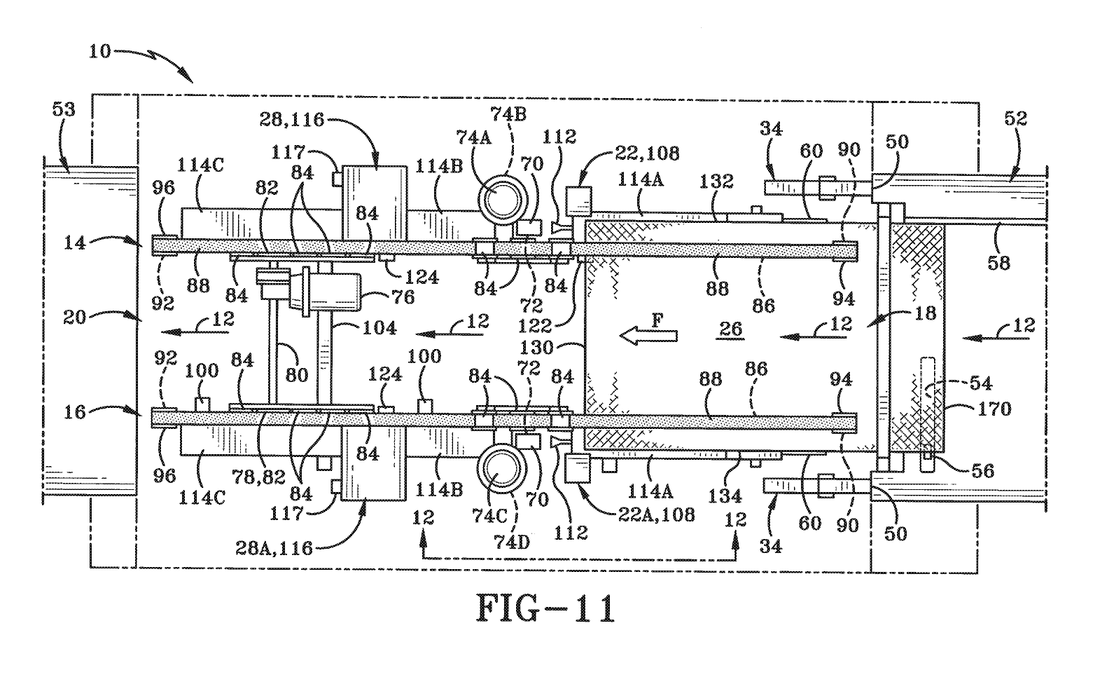

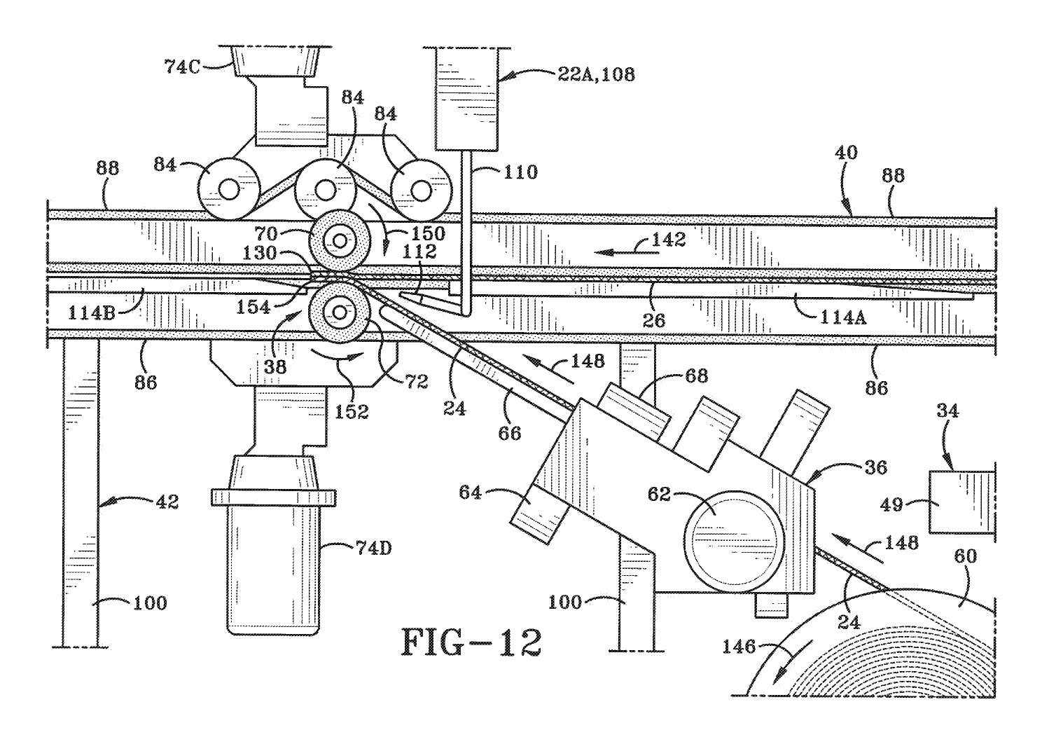

In operation, and with reference to FIG. 11, leading edge 130 approaches second sensor 122. As leading edge 130 passes over sensor 122, a signal is sent to the control system 136 in order to begin feeding the strip of reinforcing material 24 up from reel 60 via the feeder assembly. As depicted in FIG. 12, as banner material 26 is moving downstream along the pathway in the direction of arrow 142, the strip of reinforcing material is being unwound from reel 60 in the direction of rotational arrow 146. Strip 24 then proceeds linearly in the direction of arrow 148 which is both upwardly and downstream when viewed from the side. Reinforcing strip 24 proceeds through feeder assembly 36 atop plate 66 towards heat wedge 112 of the welder 22.

Weld plate 112 is heated by heater 108 via heat transfer member 110 to a temperature hot enough to impart heat into the banner and strip to fuse the banner 26 and the strip of reinforcing material 24 together. The heat of wedge 112 is transferred to strip 24 as the strip 24 passes beneath wedge 112 atop plate 66. The heat from wedge 112 transfers to banner material 26 as banner material flows over the gap defined between support plate 114A and support plate 1148. The strip of reinforcing material 24 and banner material 26 meet and are joined together at the pinch rollers 38. More specifically, banner 26 and reinforcing strip 24 are pinched together between upper roller 70 and lower roller 72. Upper roller 70 rotates in the direction of rotational arrow 150 and lower roller 72 rotates in the direction of rotational arrow 152 opposite that of arrow 150. When joined as a union and welded together, the leading edge 130 of banner 26 is directly above leading edge 154 of strip of reinforcing material 24. The two leading edges 130, 154, continue moving downstream along the pathway 12 in the direction of arrow 142 and a strip of reinforcing material 24 is continuously welded to banner 26 as reinforcing strip 24 continues to flow upwardly in the direction of arrow 148 and heated by wedge 112 just before moving through pinch rollers 38 and being joined with banner 26. It should be noted that while the welding of reinforcing strip 24 to banner 26 occurs outside the belt drives 86, 88, clearly other physical locations relative to sides 14, 16 are entirely possible. In the shown embodiment, both belts 86, 88 are inside relative to the linear center line along pathway 12 relative to welder 22.

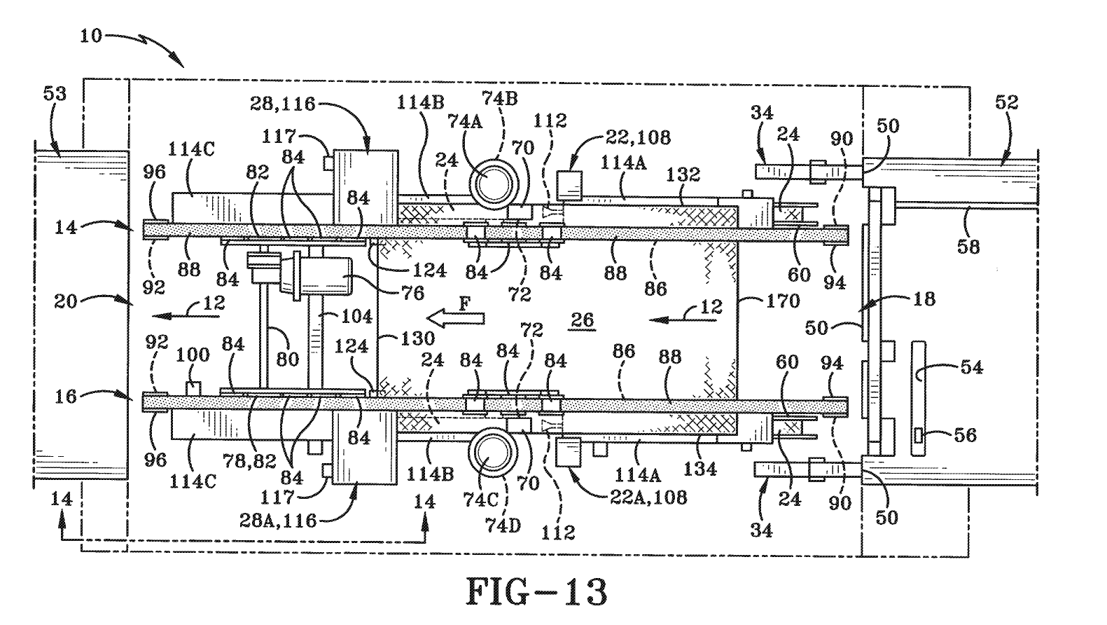

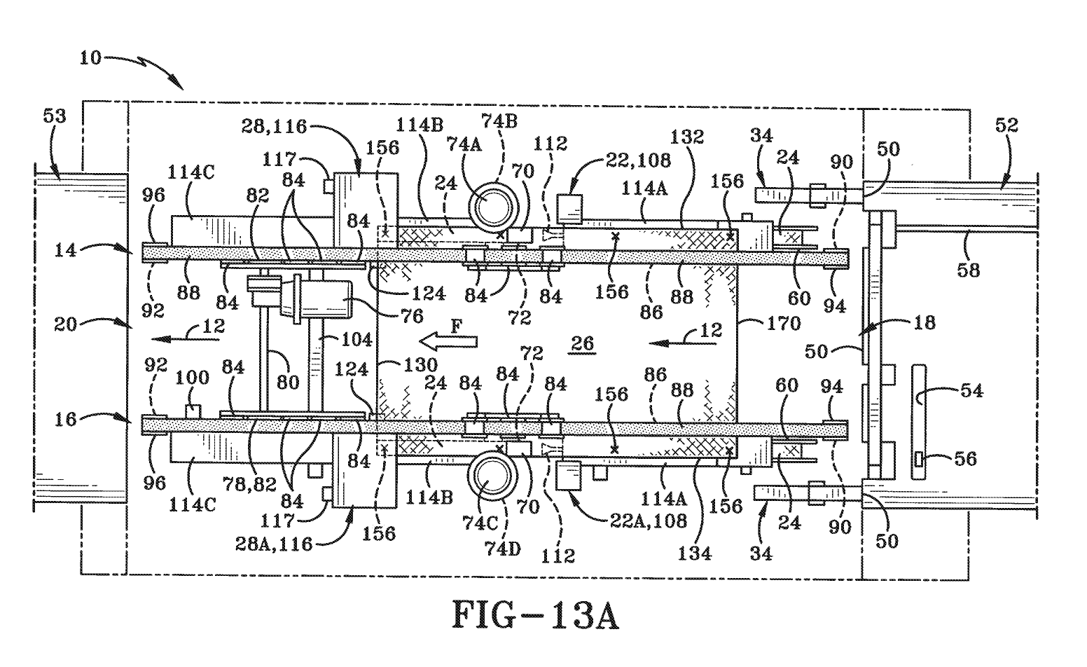

In operation and with reference to FIG. 13, banner 26 continues moving downstream along pathway 12 until leading edge 130 passes sensor 124. Sensor 124 sends a signal through control system 136 to riveter 28 wherein the signal includes a rivet sequence as determined by control system 136 for applying grommets 30. In the shown embodiment of FIG. 13, the grommets may be applied at regular intervals. In an alternative embodiment, such as that depicted in FIG. 13A, banner 26 may be pre-printed with crosshairs 156. An electronic eye within riveter 28 sees crosshairs 156 and fires a grommet 30 through banner material 26 and reinforcing strip 24 at the location of crosshair 156. Crosshairs 156 may be printed at irregular intervals, if desired.

In operation and with reference to FIG. 14, upper portion 116 of riveter 28 fires top half of a grommet 30A downwardly in the direction of arrow 158. Lower portion 118 of grommet riveter 28 fires a bottom half grommet 30B upwardly in the direction of arrow 160. Each half of the grommet 30A, 30B meet and are joined in a riveted union securing to each other to form grommet 30 through banner material 26 and reinforcing strip 24. Upper portion 116 includes a hopper retaining upper half grommets 30A and sensor 117 senses when upper half grommets 30A are running low. In the event that upper half grommets 30A are running low, sensor 117 sends a signal to control system 136 to alert an operator that a refill of upper half grommets is needed. Similarly, sensor 119 senses when lower half grommets 30B are low in their respective hopper and may send a signal similar to that of sensor 117 to control system 136. Rivet logic instructs a riveting sequence for the first and second riveters 28 (on each side 14, 16) to rivet grommets into the material and reinforcing strip, wherein the rivet logic selectively permits uniform grommet placement and non-uniform rivet placement.

In operation and with continued reference to FIG. 14, drive motor 76 is operatively connected to slip union 78 via axle 80. Axle 80 extends transversely across pathway 12 between drive roller 82, adjacent first side 14, and drive roller 82, adjacent second side 16. Each drive roller 82, along each respective side 14, 16 of machine 10 is operatively coupled to drive belt 86 which moves banner 26 downstream from entrance 18 towards exit 20. Drive belt 86 is preferably in continuous contact with the bottom surface of banner material 26. In a preferred embodiment, each drive belt 86 along sides 14, 16 is driven by drive wheel 82 via motor at the same rate. This feature is important such that banner 26 remains square as it moves downstream from entrance 18 towards exit 20. However, there may be some instances in which the banner becomes misaligned or out of square. If this occurs, slip union 78 allows one of the drive wheels 82 to momentarily slow down until the banner is pulled square and may continue moving downstream in a square manner.

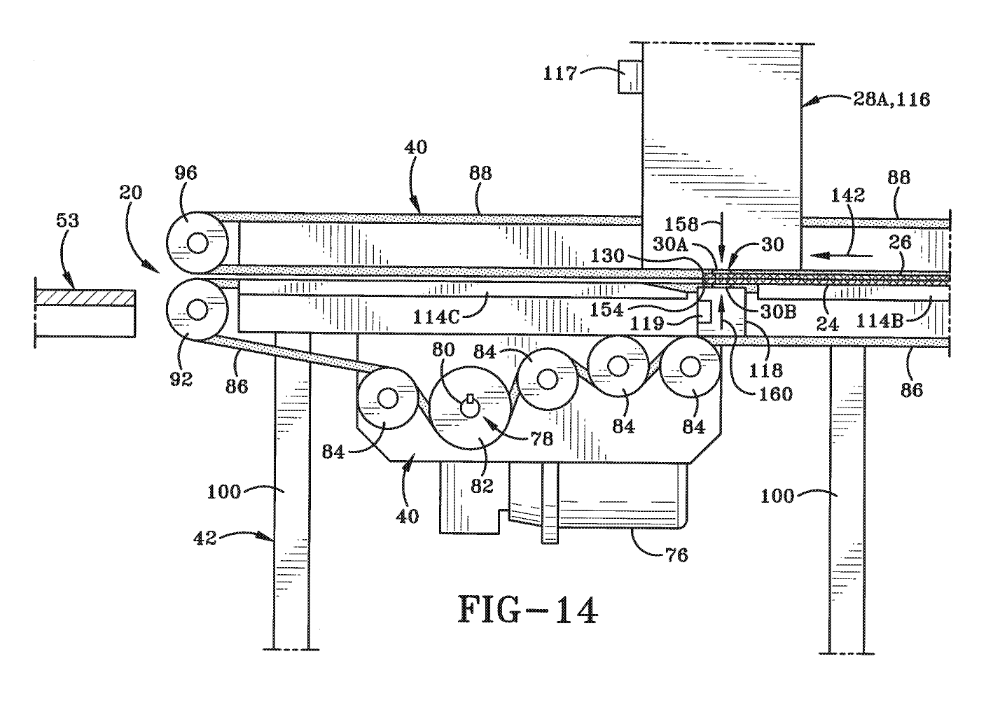

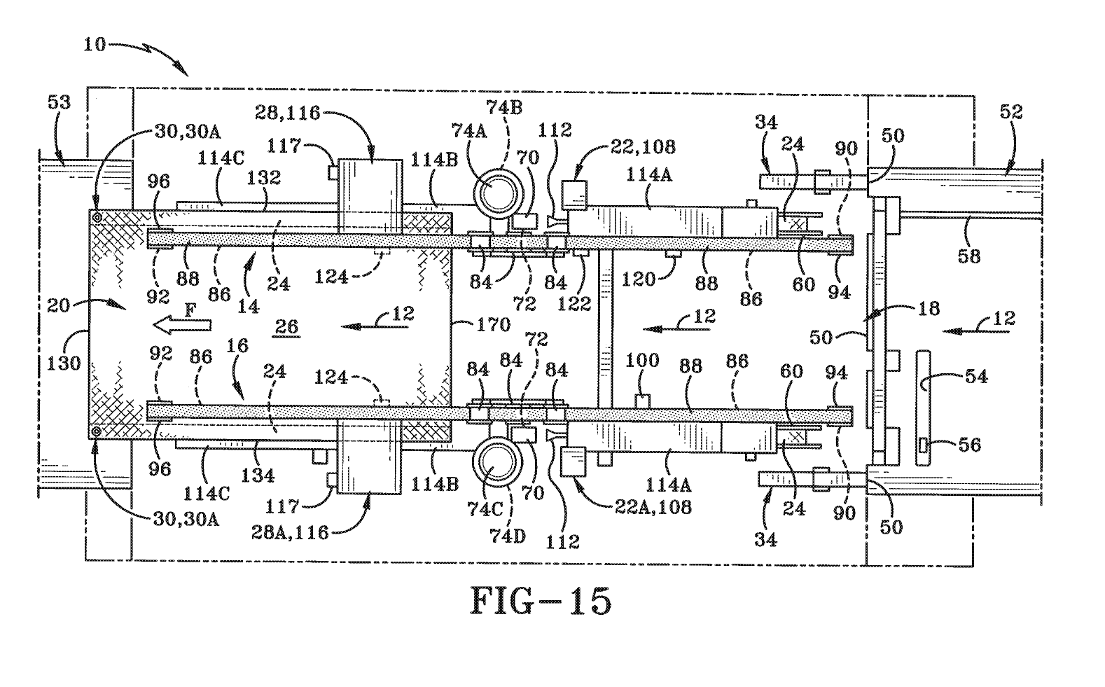

In operation and with reference to FIG. 15, banner 26 continues moving downstream along pathway 12 in the direction of flow arrow F. Leading edge 130 is driven downstream by drive belt 86 such that leading edge 130 of banner 26 passes and is downstream from rollers 92, 96. Leading edge 130 of banner 26 then passes through exit 20 and begins to come to rest on table 53 downstream from machine 10. As leading edge 130 is exiting machine 10, trailing edge 170 is approaching grommet riveter 28 where trialing edge 170 will receive grommets 30 similar to that of leading edge 130. While banner 32 is collected on table 53, there may exist a collection assembly downstream from self-contained banner making machine to collect an assembled banner 32 having reinforcement strips welded thereto and grommets riveted therethrough.

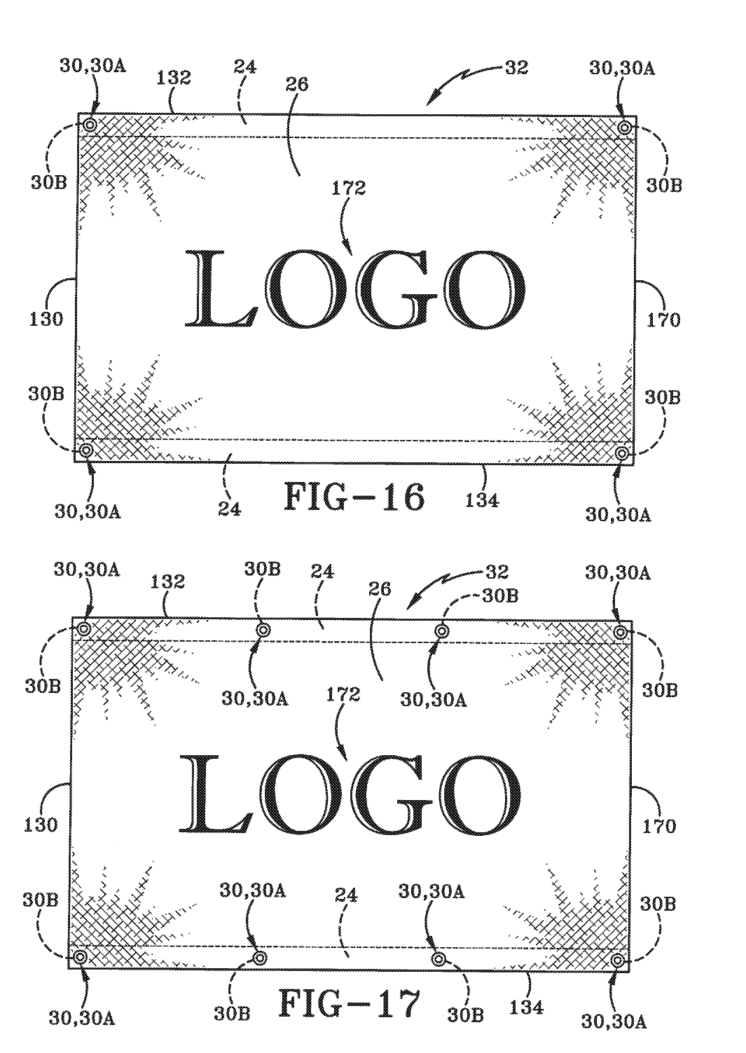

As depicted in FIG. 16 and FIG. 17, the completed banner 32 that comes to rest upon table 53 downstream from machine 10 may include a plurality of rivets 30 extending through the banner material 26 and the reinforcing strip 24. A user may selectively desire the location of grommets 30. In one particular embodiment, grommets 30 are positioned in the corners of completed banner 32. In another particular embodiment, the completed grommets are positioned uniformly along each respective longitudinal edge 132, 134 of completed banner 32. Further, in the shown embodiment, the printed logo 172 was printed on banner material 26 prior to entering machine 10. However, it is contemplated that there may be some versions of machine 10 that incorporate a printing aspect to print a desired logo 172 onto banner material 26 within machine 10.

Machine 10 is contemplated as operating in three different modes. However, clearly other modes are entirely possible. A first mode utilizes predetermined banner sizes, a second mode is a manual mode, and a third mode is a feed mode. With reference to the first mode, the banner 26 is placed onto the table 52 and may be scanned for a barcode printed on the banner material 26. The barcode is encoded with digital information indicating a plurality of descriptive features of the banner such as size, grommet locations, and length of reinforcing material to be applied. When the banner 26 is on the table, a plurality of lights on the computer may relay information to the operator regarding the status of machine 10. A green light may indicate that the machine is ready for use; a yellow light may indicate that the machine is not ready. After scanning the barcode, the machine determines whether the banner 26 is in a correct orientation, such as the printed side up, or that the correct size and settings are to be applied. In one exemplary embodiment, the operator may select, via the computer, desired settings for the banner such as indoor/outdoor settings. Additionally, another exemplary embodiment allows for the operator to select a pre-determined banner size in the event no barcode is present where the banner sizes may range from small, to medium, to large, and to extra-large. With the banner 26 on the table 52, the operator aligns the banner 26 to the lip edge 58 and the sensor 56 determines if the banner is square while simultaneously determining the width of the banner in order to move the carriage 42 to a complimentary width such that a reinforcing strip is applied on each longitudinal side of the banner's bottom surface as it moves down the pathway. When the sensor determines that the banner is square, the clamp will close to secure the banner in the clamping device. The operator may then push the start button to begin the process of banner making machine 10. The transport drive system 40 then grasps the leading edge of the banner via belts 86, 88 and moves it downstream along the pathway. The banner 26 continues to move downstream towards the pair of pinch rollers 38 and, as the banner moves through the pinch rollers, the strip of reinforcing material 24 is moved towards the pinch rollers 38 simultaneously. The banner 26 and the reinforcing strip 24 are heated by the welder 22 just upstream from the pinch rollers 38 such that when the banner 26 and the reinforcing strip 24 meet and travel through the pinch rollers 38, they are sufficiently heated creating a weld as pressure is applied as the two pieces are joined moving through the pinch rollers. The leading edge 130 of the banner 26, now having a strip of reinforcing material 24 welded thereto, now travels towards the grommet riveter 28 which fires a grommet 30 adjacent the leading edge 130 of the banner. Sensors along the pathway sense the trailing edge of the banner which communicates with the cutter 68 to trim the strip of reinforcing material to a length equal to that of the banner. The remaining portion of the banner is welded with a reinforcing strip until the trailing edge of the banner exits the pinch rollers and moves towards the grommet riveter where the grommet riveter fires a grommet through the banner and the reinforcing strip adjacent the trailing edge 170. The banner, having a reinforcing strip welded thereto and a grommet attached there through, now travels via the drive assembly towards the exit of the machine. While this description was made with reference to the general flow of the banner, it is to be understood that this process occurs on each side of the pathway such that a strip of reinforcing material is on each side of the completed banner.

With reference to the second mode of operating machine 10, the operator may set machine 10 to operate in a manual mode. When operating in a manual mode, each side 12, 14 of machine 10 are independently operable from each other. Components of machine 10 operating along first side 14 may form a weld and rivet grommets 30 to the banner 26 at separate intervals and even slightly different speeds if so desired by the operator. In this second mode, an operator places a sheet of banner material 26 onto the table 52 and aligns the banner 26 in a square position with the lip 58. The operator then selectively determines desired output features of the banner through input with the computer. The operator may select whether corner grommets are desired, the temperature of the heater, and whether the left and right sides of machine 10 will operate independently or in unison. When these options are selected, a green indicator light will indicate that the machine is ready for use. After the operator actuates a start button, the clamps secure the banner and travel towards the belt drive system with the banner secured therein. The clamp then opens and the banner is driven downstream along the pathway by belt drive system 40 on each side of the banner. The leading edge sensor senses the leading edge in order to fire a grommet adjacent to the leading edge corners, if that setting is manually input by the user. The leading edge 130 then travels through the welding pinch rollers 38 where it meets and is welded with a strip of reinforcing material 24 that has been heated by the welder 22. As the heated strip of reinforcing material 24 and the heated banner 26 pass through the pinch rollers 38, they are welded, or fused, together and are subjected to pressure by the upper and lower rollers 70, 72. The leading edge 130, now having a strip of reinforcing material 24 welded thereto, proceeds forwards to the grommet riveter 28 where the sensors sense the leading edge in order to rivet a grommet near the corner of the banner. Looking now to the trailing edge of the banner, a sensor senses the trailing edge 170 and determines the length of reinforcing material 24 that needs to be cut via cutter 68 such that it is of a complimentary length of the banner material. The strip of reinforcing material and the banner material continue downstream until a continuous weld is formed from the leading edge down to the trailing edge between the banner material and the strip of reinforcing material.

With reference to the third mode of operation of machine 10, the operator may set machine 10 to a feed mode. The feed mode should run at maximum speed for machine 10. When banner 26 is placed upon table 52, a green light on computer control system 136 will indicate whether or not machine 10 is square. The feed mode includes a timer that determines and sets a length of time that banner 26 will be clamped in the clamp assembly. It should be noted that when machine 10 is in the feed mode, the carriage assembly should be at its maximum width. An operator then actuates a physical start button which turns off a green light that indicated the machine was ready for operation. The actuation of the start button initiates movement of the drive assembly and the welding rollers. The clamp assembly then carries banner 26 into contact with the drive assembly and drive belts 86, 88 which then pull banner 26 downstream in a manner similar to that described above.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

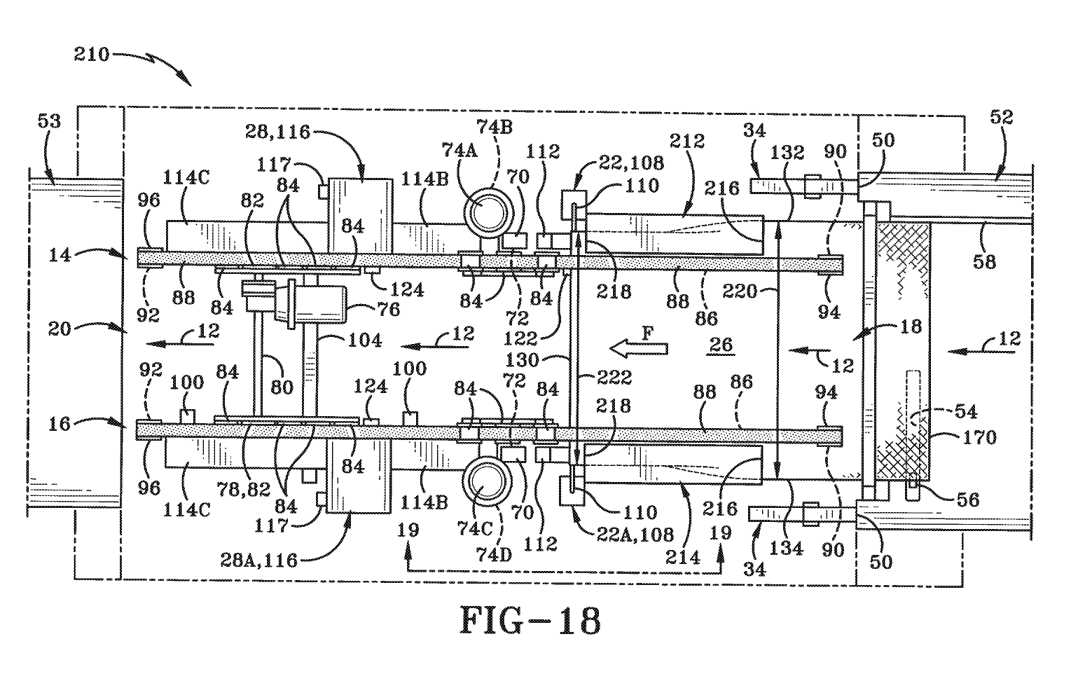

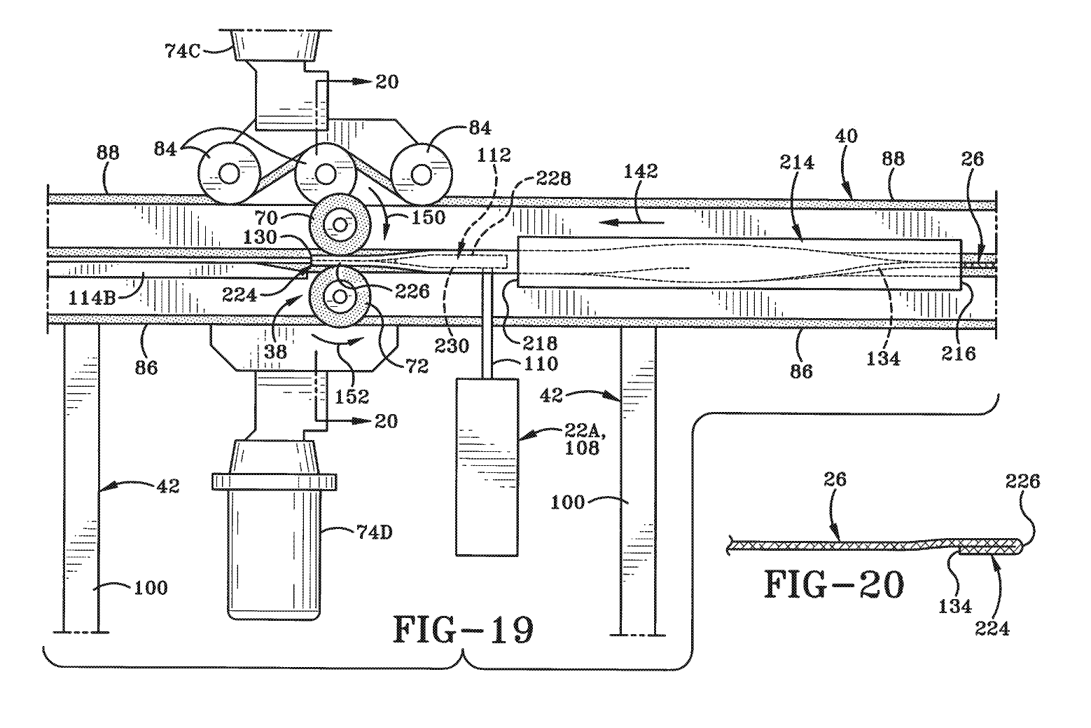

As depicted in FIG. 18 through FIG. 20, an additional embodiment of a banner making machine is depicted generally as 210. Banner making machine 210 includes a machine entrance 18 forward from a machine exit 20. A banner material flow stream pathway 12, including first and second sides, extends from the machine entrance 18 to the machine exit 20. A first banner folding device 212 having a first end 216 and a second end 218 is positioned between the entrance 18 and the exit 20 adjacent one side of pathway 12. First banner folding device 212 is configured to fold one edge 134 of banner material 26 about itself creating a first hem 224. A first grommet riveter 28 is positioned between the entrance 18 and the exit 20 downstream from the first banner folding device 212. Grommet riveter 28 rivets a grommet through the first hem 224.

Banner material 26, moving along pathway 12 in banner making machine 210, has a first width 220 measured perpendicular relative to pathway 12 before first end 216 of banner folding device 212. Banner material 26 also has a second width 222 measured perpendicular relative to pathway 12 after second end 218 of banner folding device 212. The first width 220 is greater than the second width 222.

Banner making machine 210 may also include a first welder 22 positioned downstream from the first banner folding device 212. The first welder 22 is configured to weld a first hem 224 having a double thickness. The first welder 22 may include a heated wedge 112 having opposed first and second sides 228, 230 wherein the folded banner material 26 is heated while it passes along the first and second sides 228, 230 of the heated wedge 112. Banner making machine 210 may further include temperature logic to control the temperature of the heated wedge selectively set by an operator. The temperature logic is configured to heat the wedge in order to heat the moving banner material 26 to a sufficiently high temperature such that when the banner material 26 passes through a set of pinch rollers 38 downstream from the heated wedge 112, the pressure of the pinch rollers 38 and the heated material causes a bond to occur such that the hem 224 is formed and sealed by the banner material 26 sticking to itself without the need for any foreign substance such as an adhesive or the like.

A second banner folding device 214 having a first end 216 and a second end 218 may be positioned between the entrance 18 and the exit 20 adjacent an opposite side of pathway 12 than first folding device 212. Similar to first banner folding device 212, the second banner folding device 214 is configured to fold one edge of banner material 26 about itself creating a second hem opposite the first hem 224. A second welder 22A is positioned downstream from the second banner folding device 214 and the second welder is configured to weld the second hem also having a double thickness similar to the first hem. A second grommet riveter 28A is between the entrance 18 and the exit 20 positioned downstream from the second banner folding device 214 and is configured to rivet a grommet through the second hem.

Banner making machine 210 may include a transversely movable carriage 42 carrying the second banner folding device 214, the second grommet riveter 28A, and the second welder 22k Additionally, similar to the first embodiment of banner making machine 10, the banner making machine 210 may include a plurality of sensors positioned along pathway 12 configured to sense the positioning of banner material 12 as it moves downstream from entrance 18 towards exit 20. The sensors may be positioned near the first end 216 of each banner folding device 212, 214. These sensors may act similar to sensors 120 or sensors 124 ensuring the moving sheet of banner material 26 is properly aligned to flow into banner folding device 212 or second banner folding device 214.

As depicted in FIG. 20, edge 134 of banner material 26 has been deflected 180° to face an opposite direction. Here, edge 134 is deflected downwardly to lie below the bottom surface of the banner material 26 to created hem 224 and define hem edge 226. However, edge 134 may be deflected upwardly 180° such that it lies above the top surface of banner material 26 to define a double thickness hem and hem edge 226. Hem 224 adheres to itself through the heating, and application of pressure via the set of pinch rollers; no additional securing members are needed. For example, the hem is free of adhesive, stitching, or additional distinct material.

In operation, and with reference to banner making machine 210 depicted in FIG. 18 through FIG. 20, a method of making a banner may include the steps of feeding banner material 26 having a first thickness into an entrance opening 18 of banner making machine 210, wherein the banner material includes a first edge 132 and a second edge 134. The banner material 26 moves along the banner material pathway 12. A first edge 132 of banner material 26 is folded in the first folding device 212. Prior to the folding in first folding device 212, the banner material 26 has a first width 220 measured perpendicular to pathway 12 from edge 132 to edge 134. After folding device 212, the banner material 26 has a second width 222 measured from hem edge 226 to an opposed hem edge on the other side of banner material 26. The second width 222 is less than the first width 220. The folding of either edge 132 or edge 134 in a folding device creates a first hem 224. The first hem 224 has a double thickness at one side of the banner. The interior portions of banner material 26 remain a single thickness. Alternatively, banner material 26 may be fan-folded 138 while moving along pathway 12 having triple thickness (See FIG. 6). The banner material continues to move downstream where the folded material defining hem 224 passes over a heating wedge 112. The hem edge 226 wraps around heat wedge 112 such that a downwardly facing bottom surface of banner material 26 passes over the upwardly facing first surface 228 on heated wedge 112. Additionally, an upwardly facing surface of the folded portion of hem 224 passes beneath the downwardly facing second bottom surface 230 on heated wedge 112. This arrangement allows the folded surfaces facing each other on hem 224 to be heated by wedge 112. The hem surfaces heat up and then pass through a set of pinch rollers 38 rotating in the direction of arrow 150 and arrow 152. The set of pinch rollers 38 apply pressure to hem 224 welding the banner material 26 to itself without the need for any additional matter such as an adhesive. The banner material is allowed to cool and the hem 224 made from self-adhered banner material stiffens as it cools.

Additionally, with respect to the method of operation, each banner folding device 212 or 214 is configured to deflect an edge of banner material 180° to face an opposite direction. It is clearly contemplated that the first edge may be deflected upwardly 180° such that it lies above the top surface of banner material 26. Alternatively, the first edge may be deflected downwardly to lie below the bottom surface of the banner material 26.

Additionally, with respect to the operation, prior to the step of feeding banner material having the first thickness into the entrance of the banner making machine, may also include the step of: fan folding banner material near an interior portion (See FIG. 6) of the banner between the first and second edges, the fan folded banner material having at least triple thickness, wherein the fan folded banner has folded width from edge-to-edge less about 36 inches and has an unfolded width less than about 10 feet.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

What is claimed:

1. A banner making machine comprising:
a machine entrance forward from a machine exit;
a banner material flowstream pathway, including first and second sides, extending from the machine entrance to the machine exit;
a first banner folding device having first and second ends and positioned between the entrance and exit adjacent one side of the pathway configured to fold one edge of banner material about itself creating a first hem; and
a first grommet riveter between the entrance and exit positioned downstream from the folding device to rivet a grommet through the first hem.

2. The banner making machine of claim 1, wherein banner material has a first width measured perpendicular relative to the pathway at the first end of the banner folding device and a second width measured perpendicular relative to the pathway at the second end of the banner folding device; and
the first width greater than the second width.

3. The banner making machine of claim 2, further comprising:
a first welder positioned downstream from the first banner folding device configured to weld the first hem having a double thickness.

4. The banner making machine of claim 3, further comprising:
a second banner folding device having first and second ends, the second banner folding device between the entrance and exit adjacent an opposite side of the pathway configured to fold one edge of banner material about itself creating a second hem opposite the first hem;
a second welder positioned downstream from the second banner folding device configured to weld the second hem having double thickness; and
a second grommet riveter between the entrance and exit positioned downstream from the second banner folding device adapted to rivet a grommet through the second hem.

5. The banner making machine of claim 4, further comprising:
a transversely movable carriage carrying the second banner folding device, the second grommet riveter, and the second welder;
an actuator operatively coupled to the carriage for moving the carriage.

6. The banner making machine of claim 4, further comprising:
a plurality of sensors position along the pathway configured to sense positioning of banner material.

7. The banner making machine of claim 3, wherein the first welder includes:
a temperature logic;
a heated wedge having first and second sides, wherein banner material passes along each first and second side of the heated wedge to heat passing folded banner material, wherein the temperature logic controls a temperature of the heated wedge; and
a set of pinch rollers downstream from the heated wedge to apply pressure to secure the first hem.

8. The banner making machine of claim 1, wherein at the machine entrance, banner material is fan-folded having at least triple thickness.

9. The banner making machine of claim 1, further comprising:
first and second banner drive assemblies positioned adjacent each side of the pathway; and
a single motor including a slip union on a driveshaft powering both the first and second banner drive assemblies.

10. A method of making a banner, comprising the steps of:
feeding banner material having a first thickness into an entrance of a banner making machine, the banner material including first and second spaced apart edges, wherein the banner making machine moves the banner material along a material pathway;
folding the first edge in a folding device, wherein the banner material has a first width before the folding device and a second width after the folding device, and the second width less than the first width, to create a first hem;
wherein the first hem has double thickness; and
riveting a grommet with a riveting device through double thick banner material prior to the banner material passing a machine exit.

11. The method of claim 10, wherein the folding of the first edge in the folding device is accomplished by deflecting a portion of material including the first edge 180 degrees to face an opposite direction.

12. The method of claim 11, wherein the first edge is deflected upwardly and lies above a top surface of the banner material.

13. The method of claim 11, wherein the first edge is deflected upwardly and is positioned below a bottom surface of the banner material.

14. The method of claim 10, further comprising the steps of:
heating the banner material to a desired temperature configured to allow the banner material to adhere to itself when folded;
pinching the folded edge in a set of pinch rollers; and
wherein the banner material is allowed to cool and the adhered banner material stiffens as it cools.

15. The method of claim 14, wherein the banner material defining the first hem adheres to itself without any additional matter.

16. The method of claim 10, prior to the step of feeding banner material having the first thickness into the entrance of the banner making machine, includes the step of:
fan folding banner material near an interior portion of the banner between the first and second edges, the fan folded banner material having at least triple thickness.

17. The method of claim 16, wherein the fan folded banner has folded width from edge-to-edge less about 36 inches and has an unfolded width less than about 10 feet.

18. The method of claim 10, further comprising the step of:
driving banner material along the pathway with first and second drive belt assemblies positioned adjacent the first and second sides of the pathway, respectively, wherein the first and second drive belt assemblies are powered by a single motor including a slip union on a driveshaft.

19. The method of claim 10, further comprising the steps of:
heating the first hem;
applying pressure to the first hem causing the heated material to adhere to itself without the need adhesive or stitching;
riveting a grommet adjacent a leading end of the first hem;
ceasing to heat the first hem; and
riveting a grommet adjacent a trailing end of the first hem.

20. The method of claim 10, further comprising the step of:
adjusting a carriage in a direction transverse to the pathway complementing the width of the banner material at the machine entrance, wherein the carriage carries:
a second banner folding device having first and second ends, the second banner folding device between the entrance and exit adjacent an opposite side of the pathway configured to fold one edge of banner material about itself creating a second hem opposite the first hem;
a second welder positioned downstream from the second banner folding device configured to weld the second hem having a double thickness; and
a second grommet riveter between the entrance and exit positioned downstream from the second banner folding device adapted to rivet a grommet through the second hem.
